(19) United States
(12) Patent Application Publication
(10) Pub. No.: US 2026/0118627 A1
(43) Pub. Date: Apr. 30, 2026

(54) OPTICAL APPARATUS AND IMAGING APPARATUS

(71) Applicant: CANON KABUSHIKI KAISHA, Tokyo (JP)

(72) Inventor: KUNIHIKO SASAKI, Tochigi (JP)

(21) Appl. No.: 19/354,028

(22) Filed: Oct. 9, 2025

(30) Foreign Application Priority Data
Oct. 29, 2024 (JP) 2024-189683

(51) Int. Cl. G02B 7/10; G02B 7/02

(52) U.S. Cl. CPC G02B 7/10; G02B 7/021

(57) ABSTRACT

An optical apparatus includes a first component and a second component each of which moves in an optical axis direction during zooming, a first holding portion and a second holding portion each of which holds an optical element, a first driving unit that moves the first holding portion with respect to the first component, and a second driving unit that moves the second holding portion with respect to the second component, wherein the first component has a guide member that guides the first and second holding portions in an optical axis direction, and the first driving unit is held by the first component, and the second driving unit is held by the second component.

### BACKGROUND

### Field of the Technology

The present disclosure relates to an optical apparatus, and to an imaging apparatus including the optical apparatus. In particular, the present disclosure relates to an optical apparatus including a movable barrel that is driven back and forth during zooming, and in which a lens holding frame is moved with respect to the movable barrel.

### Description of the Related Art

An imaging apparatus (optical apparatus) such as a digital camera or a video camera performs variable magnification (zooming) and focus adjustment (focusing) by moving a movable lens frame that holds a lens in the optical axis direction by a driving force from a driving source.

In recent years, there has been an increase in configurations in which a lens holding frame is driven by a driving unit such as a stepping motor with respect to a movable barrel that is moved in the optical axis direction during zooming by a cam barrel.

Japanese Patent No. 7103364 discloses an example in which a movable barrel is provided with a first driving unit, a second driving unit, a first lens holding frame, and a second lens holding frame.

Additionally, Japanese Patent No. 7336500 discloses an example in which a first lens holding frame is provided in a first movable barrel, and in which a part of a fixation of a driving unit is provided divided between the first movable barrel and a second movable barrel.

### SUMMARY

An optical apparatus according to one aspect of the present disclosure comprises: a first component and a second component each of which moves in an optical axis direction during zooming; a first holding portion and a second holding portion each of which holds an optical element; a first driving unit configured to move the first holding portion with respect to the first component; and a second driving unit configured to move the second holding portion with respect to the second component, wherein the first component has a guide member that guides the first and second holding portions in an optical axis direction, and wherein the first driving unit is held by the first component, and the second driving unit is held by the second component.

Features of the present disclosure will become apparent from the following description of embodiments with reference to the attached drawings. The following description of embodiments are described by way of example.

### BRIEF DESCRIPTION OF THE DRAWINGS

FIG. 1 is a longitudinal sectional view showing a lens barrel 100.

FIG. 2 is an exploded perspective view of the lens barrel 100.

FIG. 3 is a cross-sectional view of the lens barrel 100.

FIG. 4 is a longitudinal sectional view of the lens barrel 100.

FIG. 5 is a graph showing a movement trajectory of a focusing position of a seventh lens holding frame 115 with respect to a zoom position.

FIG. 6 is a graph showing a movement trajectory of the seventh lens holding frame 115 with respect to a zoom position, with a second motor unit 116 as a reference.

FIG. 7 is a graph showing movement trajectories of a position of the movable base 108 and a position of an eighth lens holding frame 118 with respect to a zoom position, and a difference between the position of the movable base 108 and the position of the eighth lens holding frame 118.

FIG. 8 is a schematic diagram showing an imaging apparatus 2000.

### DESCRIPTION OF THE EMBODIMENTS

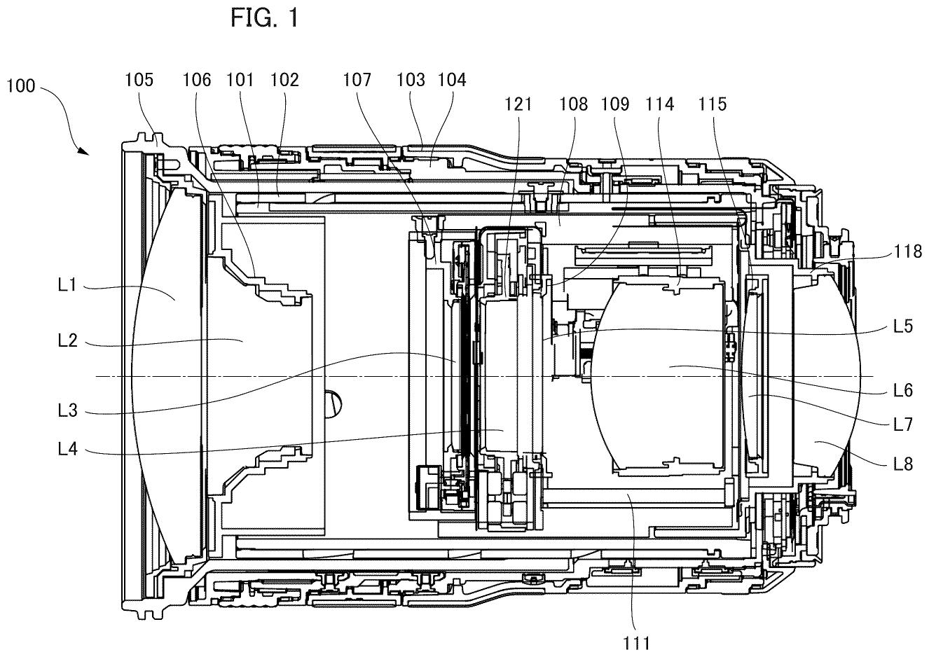

Hereinafter, an optical apparatus and a camera apparatus according to an embodiment of the present disclosure will be explained with reference to FIG. 1 to FIG. 8. However, the present disclosure is not limited to the following embodiment. It is to be noted, in each figure, the same reference numerals are given to the same members or elements, and explanation thereof will be omitted.

The present embodiment is directed to provide an optical apparatus that drives a lens holding frame with high accuracy and an imaging apparatus including the optical apparatus.

### <Lens Barrel 100>

FIG. 1 is a longitudinal sectional view showing a lens barrel 100 and is a sectional view including an optical axis at a wide-angle end (wide end). The longitudinal sectional view refers to a sectional view obtained by cutting along a plane parallel to the optical axis.

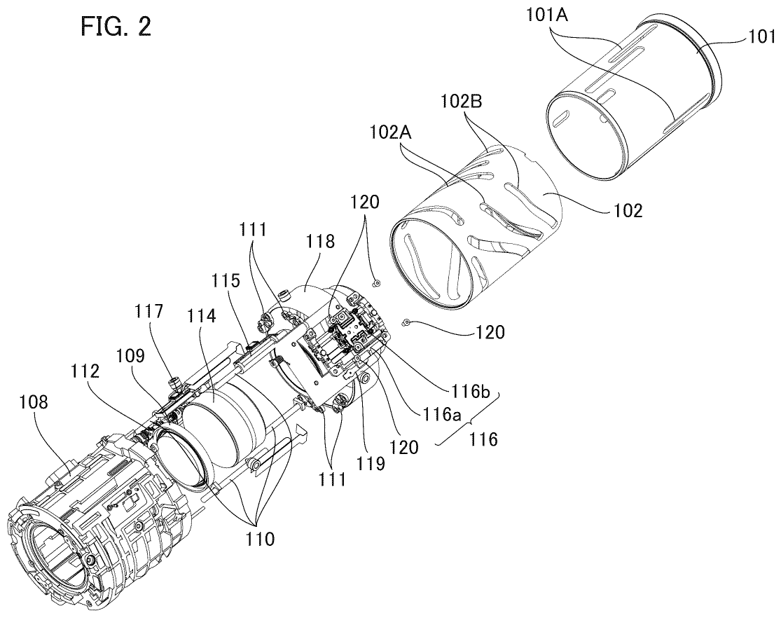

FIG. 2 is an exploded perspective view of the lens barrel 100 and is an exploded view including a fifth lens group L1 to an eighth lens group L8.

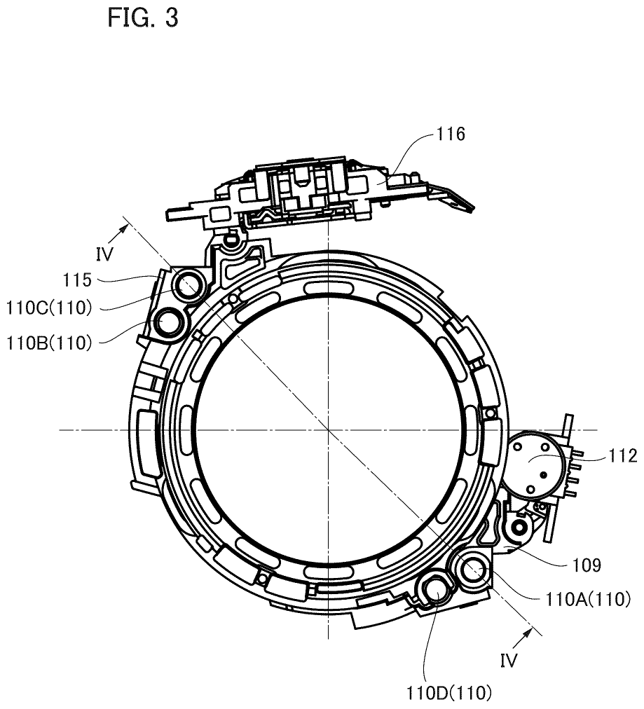

FIG. 3 is a cross-sectional view of the lens barrel 100 and is a diagram showing four guide bars 110. The cross-sectional view refers to a sectional view obtained by cutting along a plane (radial direction) that is orthogonal to the optical axis.

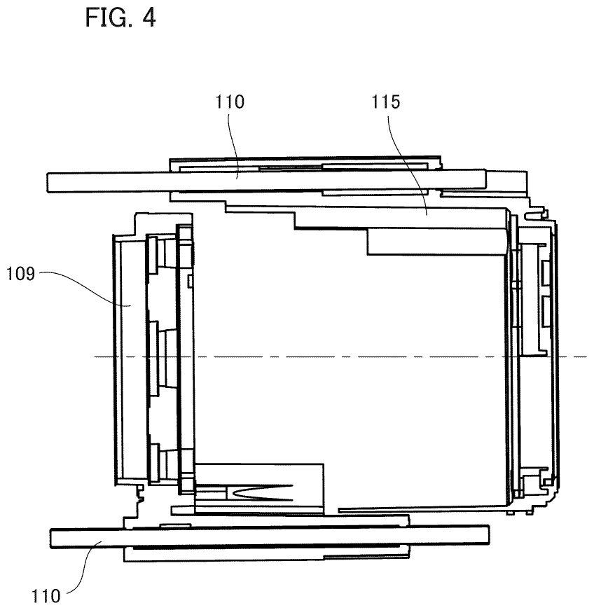

FIG. 4 is a longitudinal sectional view of the lens barrel 100 and is a diagram showing a positional relation between a fifth lens holding frame 109 and a seventh lens holding frame 115.

The lens barrel (optical apparatus, lens apparatus) 100 is an optical apparatus having an eight-group configuration composed of a first lens group L1 to an eighth lens group L8.

In the lens barrel 100, a seventh lens group L7 that is a focus lens group, and a fifth lens group L5 that is a floating lens group, respectively move in the optical axis direction.

By a zooming operation (zoom, variable magnification operation) in the lens barrel 100, all of the lens groups (the first lens group L1 to the eighth lens group L8) move in the optical axis direction along respective predetermined trajectories, and change the focal length.

At that time, a control unit (not illustrated) installed on a main circuit board drives and controls the fifth lens group L5 (the fifth lens holding frame 109) and the seventh lens group L7 (the seventh lens holding frame 115) so that the focus position changed by the zooming operation and each aberration amount are suppressed.

The lens barrel 100 includes a guide barrel 101, a cam barrel 102, a zoom operation barrel 103, and a fixed barrel 104.

The guide barrel 101 is a member in which rectilinear grooves 101A that guide each movable barrel (the movable base 108 and the eighth lens holding frame 118) in a rectilinear direction are formed.

The cam barrel 102 is a member (rotatable barrel) that is disposed in close contact with an outer circumferential surface side of the guide barrel 101. The cam barrel 102 rotates about the optical axis by a zooming operation.

In the cam barrel 102, four types of cam grooves 102A and 102B that correspond to the trajectories of each movable barrel during the zooming operation are formed. Two cam grooves 102A and two cam grooves 102B are formed.

The zoom operation barrel 103 is a member that is disposed in close contact with an outer circumferential surface side of the fixed barrel 104. The zoom operation barrel 103 is held rotatably about the optical axis with respect to the fixed barrel 104.

In the zoom operation barrel 103, a zoom key (not illustrated) is formed, and the rotational force is transmitted to the cam barrel 102 via this zoom key.

The lens barrel 100 has a configuration in which, by the cam barrel 102 rotating with respect to the guide barrel 101, each movable barrel moves along the optical axis by the action of the respective cam followers, the respective rectilinear grooves, and the respective cam grooves.

Note that, as shown in FIG. 4, when viewed in a radial direction, a part of each of the fifth lens holding frame 109 and the seventh lens holding frame 115 overlaps the movable base 108 or the eighth lens holding frame 118.

The lens barrel 100 includes a plurality of lens group units and holding frames corresponding to the respective lens groups.

A first group unit 105 is an optical unit (holding frame) that holds the first lens group L1.

The first group unit 105 is provided with a cam follower (not illustrated). The first group unit 105 and the first lens group L1 are advanced and retracted in the optical axis direction by this cam follower through the zooming operation.

A second group unit 106 is a holding frame that holds the second lens group L2. The second group unit 106 is provided with a cam follower (not illustrated). The second group unit 106 and the second lens group L2 are advanced and retracted in the optical axis direction by this cam follower through the zooming operation.

The movable base (first component) 108 is provided with a cam follower (not illustrated). This cam follower engages the rectilinear groove 101A of the guide barrel 101 and the cam groove 102A of the cam barrel 102, respectively. The movable base 108 is advanced and retracted in the optical axis direction by the zooming operation.

A third lens holding frame 107 is a holding frame that holds the third lens group L3. The third lens holding frame 107 is held in engagement with the movable base 108 via cam followers (three rollers). The third lens holding frame 107 and the third lens group L3 are advanced and retracted in the optical axis direction by the zooming operation.

A fourth lens holding frame 113 is a holding frame that holds the fourth lens group L4. The fourth lens holding frame 113 constitutes part of a shake correction unit. The shake correction unit holds the fourth lens holding frame 113 so as to be drivable in a direction orthogonal to the optical axis (optical axis orthogonal direction), and performs shake correction by driving the fourth lens holding frame 113 by a shake correction driving unit composed of a magnet and a coil.

The shake correction unit is held in engagement with the movable base 108 via cam followers (three rollers).

The fourth lens holding frame 113 and the fourth lens group LA are advanced and retracted in the optical axis direction via the cam follower of the movable base 108 in accordance with the zooming operation.

The fifth lens holding frame (first holding portion) 109 is a holding frame that holds the fifth lens group L5 that is a floating group.

The fifth lens holding frame 109 is guided rectilinearly in the optical axis direction along two guide bars 110 (110A, 110B) with respect to the movable base 108.

When the movable base 108 is advanced and retracted in the optical axis direction by the zooming operation, the fifth lens holding frame 109 and the fifth lens group L5 are advanced and retracted in the optical axis direction with respect to the movable base 108 by the first motor unit 112.

The guide bars (guide members) 110A and 110B are rod-shaped members held by a guide bar cover 111. The guide bars 110 are arranged along the optical axis direction and are fitted into two locations of the fifth lens holding frame 109. The guide bars 110A and 110B rectilinearly guide the fifth lens holding frame 109 in the optical axis direction and restrict rotation about the optical axis.

Of the two guide bars 110, the guide bar 110A (first guide portion) that restricts tilting of the fifth lens holding frame 109 is referred to also as a main guide bar, and the guide bar 110B (first restricting portion) that restricts rotation about the optical axis is referred to also as a sub guide bar.

A first motor unit (first driving unit) 112 is fixed to the movable base 108 by fixing screws (not illustrated).

The first motor unit 112 is configured by a stepping motor, a lead screw, a rack, a rack biasing spring, and the like.

The lead screw is fixed to a shaft of the stepping motor. The rack transmits the driving force of the stepping motor. The rack biasing spring eliminates play in motor drive transmission caused by the rack and the like.

A sixth lens holding frame 114 is a holding frame that holds a sixth lens group L6. The sixth lens holding frame 114 is held in engagement with the movable base 108 by three rollers.

The sixth lens holding frame 114 and the sixth lens group L6 are advanced and retracted in the optical axis direction via the cam follower of the movable base 108 in accordance with the zooming operation.

The seventh lens holding frame (second holding portion) 115 is a holding frame that holds a seventh lens group L7 that is a focus group.

The seventh lens holding frame 115 is guided rectilinearly in the optical axis direction along two guide bars 110 (110C, 110D) with respect to the movable base 108.

When the movable base 108 is advanced and retracted in the optical axis direction by the zooming operation, the seventh lens holding frame 115 and the seventh lens group L7 are driven (moved) in the optical axis direction with respect to the movable base 108 by a second motor unit 116.

The guide bars (guide members) 110C and 110D are rod-shaped members held by the guide bar cover 111. The guide bars 110C and 110D are arranged along the optical axis direction and are fitted into two locations of the seventh lens holding frame 115. The guide bars 110 rectilinearly guide the seventh lens holding frame 115 in the optical axis direction and also restrict rotation about the optical axis.

Of the two guide bars 110, the guide bar 110C (second guide portion) that restricts tilting of the seventh lens holding frame 115 is also referred to as the main guide bar, and the guide bar 110D (second restricting portion) that restricts rotation about the optical axis is also referred to as the sub guide bar.

When viewed in a direction orthogonal to the optical axis, the main guide bar 110A that restricts tilting of the fifth lens holding frame 109 is disposed closer to the first motor unit 112 than to the sub guide bar 110B in the circumferential direction about the optical axis.

Similarly, when viewed in a direction orthogonal to the optical axis, the main guide bar 110C that restricts tilting of the seventh lens holding frame 115 is disposed closer to the second motor unit 116 than to the sub guide bar 110D in the circumferential direction about the optical axis.

The effect and advantage obtained by disposing the main guide bar 110A and the main guide bar 110C in proximity to the first motor unit 112 and the second motor unit 116 will be described in detail.

An inertial force generated by the driving force of the first motor unit 112 and the second motor unit 116 acts as a force that tilts the fifth lens holding frame 109 and the seventh lens holding frame 115.

However, by disposing the main guide bar 110A and the main guide bar 110C in proximity to the first motor unit 112 and the second motor unit 116, the generated moment is reduced.

That is, for example, it is possible to suppress destabilization of the posture of the fifth lens holding frame 109 (fifth lens group L5) and the seventh lens holding frame 115 (seventh lens group L7) due to a moment generated when the driving in the optical axis direction is reversed.

A position detection unit 117 is a position detection mechanism using a light-emitting diode, a light-receiving sensor, and a reflection scale.

The light-emitting diode and the light-receiving sensor are formed as a single package element and are disposed on the movable base 108. The reflection scales are respectively disposed on the fifth lens holding frame 109 and the seventh lens holding frame 115.

Position information of the fifth lens holding frame 109 and the seventh lens holding frame 115 obtained by the position detection unit 117 is transmitted to a control unit and fed back to a drive command for the second motor unit 116. The position detection unit 117 may have a function of detecting a moving speed of the seventh lens holding frame 115 relative to the movable base 108.

The second motor unit (second driving unit) 116 is fixed to the eighth lens holding frame 118, which will be described below, by fixing screws 120.

The second motor unit 116 is a piezoelectric motor and is configured by a motor stator 116a, a motor movable element 116b, a rack, a rack biasing spring, and the like.

The rack transmits the driving force of the piezoelectric motor. The rack biasing spring eliminates play in motor drive transmission caused by the rack and the like.

The seventh lens holding frame 115 is positionally restricted by the two guide bars 110C and 110D. The two guide bars 110C and 110D are held by the movable base 108 and the guide bar cover 111. Therefore, eccentricity and tilting of the sixth lens holding frame 114 with respect to the optical axis are defined in dependence on the movable base 108.

In contrast, the second motor unit 116 is fixed to the eighth lens holding frame 118. Accordingly, the optical axis position of the seventh lens holding frame 115 is defined in dependence on the eighth lens holding frame 118.

The eighth lens holding frame (second component) 118 is a holding frame that holds an eighth lens group L8. The eighth lens holding frame 118 is provided with a cam follower. This cam follower is engaged with the rectilinear groove 101A of the guide barrel 101 and the cam groove 102B of the cam barrel 102, respectively.

The eighth lens holding frame 118 and the eighth lens group L8 are advanced and retracted in the optical axis direction by the zooming operation.

As described above, the second motor unit 116 is fixed to the eighth lens holding frame 118 by the fixing screws 120.

The eighth lens holding frame 118 is biased in the optical axis direction with respect to the movable base 108 by an elastic member (not illustrated), and play is suppressed.

In a case in which play of a certain level or more exists in the eighth lens holding frame 118, the inertial force of driving of the second motor unit 116 causes the eighth lens holding frame 118 to rattle in the optical axis direction. In a case in which the driving unit is a VCM or a piezoelectric motor, since feedback control using a position detection system is generally performed, there is a concern that oscillation may be caused by unnecessary vibration or electrical noise. By using the elastic member, such play is eliminated, and a concern that the feedback system may erroneously recognize and thereby lead to an oscillation phenomenon is suppressed.

Power supply to the second motor unit 116 is performed by using an FPC (flexible wiring, flexible printed circuit board). The FPC is bridged between the movable base 108 and the eighth lens holding frame 118.

This FPC absorbs the trajectory difference between the movable base 108 and the eighth lens holding frame 118 by using the flexibility of the FPC during zooming.

Specifically, the FPC has a deflection absorption portion 119 protruding from the second motor unit 116, and the trajectory difference is absorbed by the deflection absorption portion 119. The FPC is fixed to the movable base 108 and is connected by wiring to the main circuit board.

An effect and advantage of the second motor unit 116 being fixed to the eighth lens holding frame 118 will be described in detail in comparison with a general configuration example.

The general configuration example refers to a configuration in which the second motor unit 116 is fixed to the movable base 108.

In the lens barrel 100, the driving force from the first motor unit 112 and the driving force from the second motor unit 116 are transmitted, respectively, to the fifth lens holding frame 109 and the seventh lens holding frame 115 by focusing.

At this time, vibration occurs in the first motor unit 112 and the second motor unit 116. This vibration is mainly transmitted to the movable base 108 to which the first motor unit 112 and the second motor unit 116 are fixed, and to the eighth lens holding frame 118. Then, vibration is also transmitted to the guide barrel 101 and the cam barrel 102 through the respective cam followers that hold the movable base 108 and the eighth lens holding frame 118.

In contrast, in the general configuration example, the first motor unit 112 and the second motor unit 116 are fixed only to the movable base 108. Accordingly, vibrations of the respective units are simultaneously transmitted to the movable base 108, and the vibration is amplified.

Additionally, electrical noise is also transmitted, and a striking sound (also referred to as a beat sound) may be generated due to harmonic components.

Additionally, in the lens barrel 100, the guide bar 110A that holds the fifth lens holding frame 109 and the guide bar 111C that holds the seventh lens holding frame 115 are both disposed on the movable base 108.

Accordingly, the number of components between the fifth lens holding frame 109 and the seventh lens holding frame 115 is reduced, variations in eccentricity and tilting due to tolerances are suppressed, and optical performance can be stabilized.

In contrast, in the general configuration example, since the guide bar 110C that holds the seventh lens holding frame 115 is disposed on the eighth lens holding frame 118, the error with respect to the fifth lens holding frame 109 increases. Accordingly, there is a concern that the optical performance may deteriorate.

Next, the driving of the seventh lens group L7 and the eighth lens group L8 during a zooming operation, and the driving trajectory (tracking curve), will be described in detail.

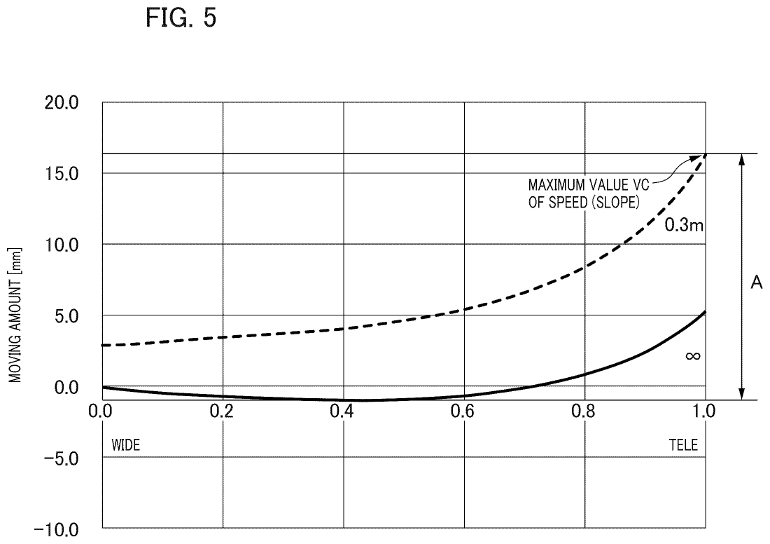

FIG. 5 is a graph showing the trajectory of movement of the focusing position of the seventh lens holding frame 115 with respect to the zoom position (focal length). That is, it is the trajectory of movement of the seventh lens holding frame 115 in the above-described general configuration example.

Hereinafter, the focusing position of the seventh lens holding frame 115 with respect to the zoom position refers to a lens focusing position.

In FIG. 5, the horizontal axis represents the zoom position (focal length) and continuously indicates from the wide-angle end (wide) to the telephoto end (tele).

The horizontal axis represents the rotation angle of the zoom operation barrel 103, and is normalized by setting the wide-angle end to 0 and the telephoto end to 1.

The vertical axis represents the position of the seventh lens holding frame 115, taking as a reference (0) the state in which focus is on an infinite distance on the wide-angle side. Additionally, the vertical axis is defined as positive on the imaging surface side and negative on the object side.

A solid line indicates the lens focusing position of the seventh lens group L7 that is in focus at an infinite distance.

A broken line indicates the lens focusing position of the seventh lens group L7 that is in focus at a subject distance of 0.3 m (close).

In FIG. 5, since the detection position detected by the position detection unit 117 is used as a reference, the actual position information during feedback control is shown.

Because the position detection unit 117 and the guide bar 110 are disposed on the movable base 108, this is equivalent to using the movable base 108 or the guide bar 110 as a reference.

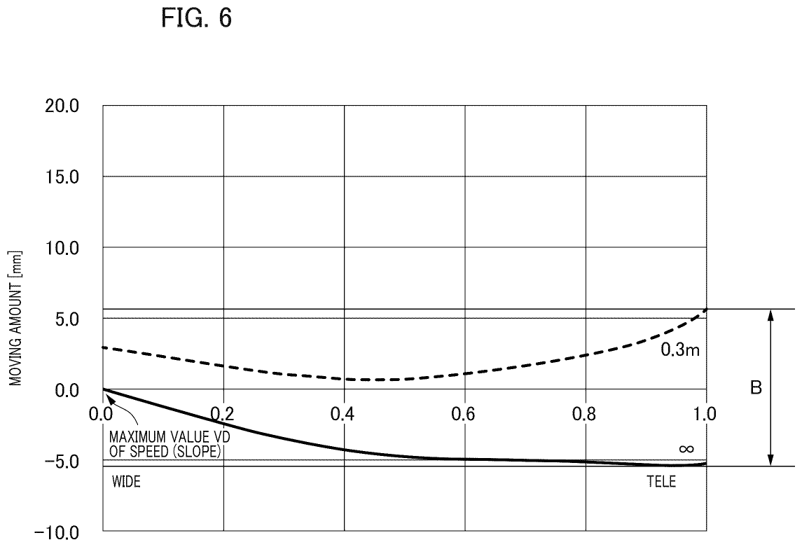

FIG. 6 is a graph showing the movement trajectory of the seventh lens holding frame 115 with respect to the zoom position, with the second motor unit 116 as a reference. That is, FIG. 6 is the movement trajectory of the seventh lens holding frame 115 in the lens barrel 100.

FIG. 6 shows the actual movement amount of the seventh lens holding frame 115 that is driven by the second motor unit 116. Additionally, the graph of FIG. 6 can also be expressed as the movement amount of the seventh lens holding frame 115 with the eighth lens holding frame 118 as a reference. This moving amount corresponds to position information obtained by a second position detection unit (not illustrated) that is disposed on the eighth lens holding frame 118. The second position detection unit may have a function of detecting the speed of the seventh lens holding frame 115 with the eighth lens holding frame 118 as a reference.

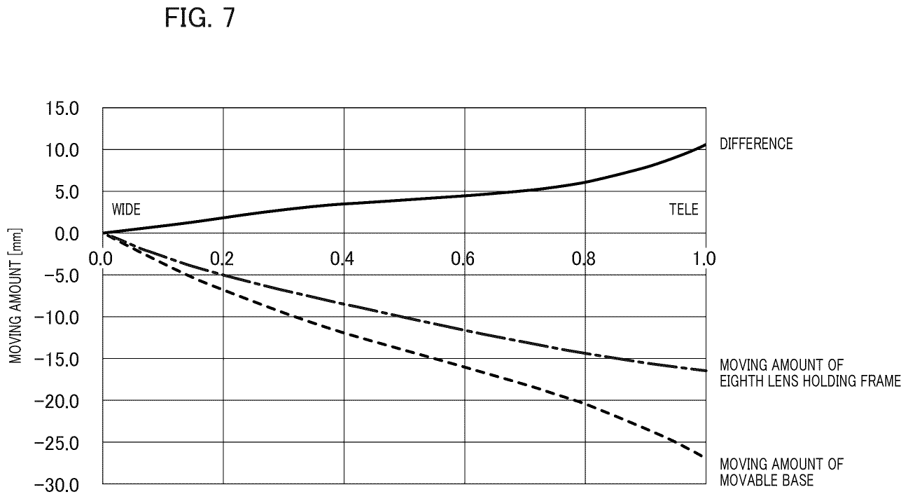

FIG. 7 is a graph showing the movement trajectories of the position of the movable base 108 and the position of the eighth lens holding frame 118 with respect to the zoom position (focal length), and the difference between the position of the movable base 108 and the position of the eighth lens holding frame 118.

A broken line indicates the position of the movable base 108 with respect to the zoom position.

A one-dot chain line indicates the position of the eighth lens holding frame 118.

A solid line indicates the difference between the position of the movable base 108 and the position of the eighth lens holding frame 118.

The horizontal axis represents the zoom position (focal length) and continuously indicates a range from the wide-angle end (wide) to the telephoto end (tele).

The vertical axis represents each position, taking as a reference (0) the position at an infinite object distance at the wide-angle end.

The difference shown in FIG. 7 is the difference between the movement amount of the movable base 108 detected by the position detection unit 117 during a zooming operation, and the movement amount of the eighth lens holding frame 118 driven by the second motor unit 116.

The difference amount for each zoom position is stored in a memory circuit of the main circuit board and is used during control.

As shown in FIG. 5, in the general configuration example, the position detection unit 117 serves as a reference, and the movement amount (movement distance) of the seventh lens holding frame 115 is A in the drawing.

On the other hand, as shown in FIG. 6, in the lens barrel 100 of the present disclosure, the second motor unit 116 serves as a reference, and the movement amount (movement distance) of the eighth lens holding frame 118 driven by the second motor unit 116 is B in the drawing.

Thus, in the lens barrel 100, the movement amount B of the eighth lens holding frame 118 can be made smaller than the movement amount A of the seventh lens holding frame 115 in the general configuration example.

That is, the maximum value A of the movement amount of the seventh lens holding frame 115 with respect to the movable base 108 and the maximum value B of the movement amount of the seventh lens holding frame 115 with respect to the eighth lens holding frame 118 satisfy A>B.

By fixing the second motor unit 116 to the eighth lens holding frame 118 rather than to the movable base 108, the drive amount (movement amount) by the second motor unit 116 can be made smaller. Therefore, the size of the lens barrel 100 can be reduced.

Note that, in a configuration in which the second motor unit 116 is fixed to the eighth lens holding frame 118 (a configuration in which the position detection unit 117 and the second motor unit 116 are separated), the following disadvantage is a concern. That is, when the user manually performs a zooming operation, the seventh lens holding frame 115 moves, with respect to the position detection unit 117, by the difference amount shown in FIG. 5. As a result, the seventh lens holding frame 115 is detected as if the seventh lens holding frame 115 moved, even though the second motor unit 116 is not driven during control.

To solve such a disadvantage, improvement of controllability, for example by shortening the sampling period of the position detection unit 117, becomes more important.

Additionally, in FIG. 5 and FIG. 6, the slope of each graph curve indicates the driving speed (movement speed) of the seventh lens holding frame 115. That is, the slope of each graph curve indicates the required speed (movement speed) of the second motor unit 116 when the zoom operation barrel 103 is rotated at a certain speed.

The absolute value of a slope at a location where the absolute value of the slope is the largest in FIG. 6 is smaller than the absolute value of a slope at a location where the absolute value of the slope is the largest in FIG. 5. That is, the lens barrel 100 can reduce the absolute value of the slope.

Specifically, in the general configuration example, the driving speed of the seventh lens holding frame 115 is VC (refer to FIG. 5). In the lens barrel 100, the driving speed of the seventh lens holding frame 115 is VD (refer to FIG. 6).

Thus, the motor driving speed VD can be made smaller than the motor driving speed VC (the speed can be made slower).

That is, the maximum value VC of the motor driving speed of the seventh lens holding frame 115 driven by the second motor unit 116 with respect to the movable base 108 and the maximum value VD of the motor driving speed of the seventh lens holding frame 115 with respect to the eighth lens holding frame 118 satisfy VC>VD.

Consequently, the required speed of the second motor unit 116 can be made smaller. Therefore, the focus tracking performance when the zoom operation barrel 103 is rotated quickly can be improved.

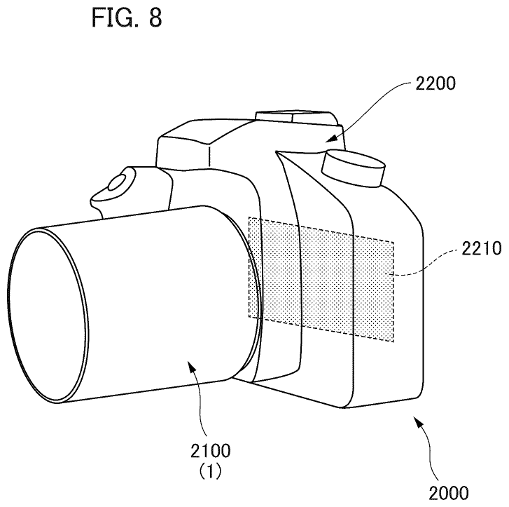

FIG. 8 is a schematic diagram showing an imaging apparatus 2000.

As shown in FIG. 8, the imaging apparatus 2000 includes a lens apparatus 2100 and a camera body 2200.

The camera body 2200 includes an imaging element 2210. The imaging element 2210 receives light from the lens apparatus 2100.

The lens apparatus 2100 includes the lens barrel 100 described above. The lens apparatus 2100 is mounted on the camera body 2200.

That is, the lens barrel 100 constitutes a part of the lens apparatus 2100 used in an interchangeable-lens camera, a compact digital camera, and the like, and is used by being attached to the camera body 2200.

The lens apparatus 2100 may be detachable from the camera body 2200 or may be non-detachable.

Since the lens apparatus 2100 includes the lens barrel 100, it is possible to realize a lens apparatus in which the effects and advantages of the lens barrel 100 can be obtained. Additionally, since the imaging apparatus 2000 includes the lens apparatus 2100 including the lens barrel 100, it is possible to realize an imaging apparatus in which the effects and advantages of the lens barrel 100 can be obtained.

While the preferred embodiment of the present disclosure has been described above, the present disclosure is not limited to these embodiments, and various modifications and alterations can be made without departing from the scope of the disclosure.

In the lens barrel 100, the above-described general configuration example may be employed.

Although, for example, in the present case, the trajectory of movement of the movable base 108 and that of the eighth lens holding frame 118 during zooming have been set as different trajectories, they may instead be set as the same trajectory. As an effect, suppression of interaction between unnecessary vibration and electrical noise of the two driving units can be expected.

Additionally, in the present embodiment, the first motor unit 112 was used as a stepping motor and the second motor unit 116 was used as a piezoelectric motor, although it is apparent that different driving methods may be used for each.

The sub guide bar 110B that restricts rotation about the optical axis of the fifth lens holding frame 109 and the sub guide bar 110D that restricts rotation about the optical axis of the seventh lens holding frame 115 may be made common.

That is, by shifting contact surfaces for restricting rotation of the fifth lens holding frame 109 and the seventh lens holding frame 115 in the optical axis direction, only one common sub guide bar (the same member) may be used.

The movable base 108 and the eighth lens holding frame 118 may directly hold optical elements (not illustrated) different from the fifth lens holding frame 109 and the seventh lens holding frame 115, or may hold lens holding frames (not illustrated) that hold optical elements.

The movable base 108 and the eighth lens holding frame 118 may move along the same trajectory during a zooming operation or may move along different trajectories.

Additionally, the movable base 108 and the eighth lens holding frame 118 may move along different side surfaces of a single cam groove. That is, the movable base 108 and the eighth lens holding frame 118 move along trajectories on different side surfaces of a single cam groove. At this time, the movable base 108 and the eighth lens holding frame 118 are urged toward a side surface of the cam groove by an elastic member.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-189683, filed Oct. 29, 2024, which is hereby incorporated by reference herein in its entirety.

What is claimed is:

1. An optical apparatus comprising:
a first component and a second component each of which moves in an optical axis direction during zooming;
a first holding portion and a second holding portion each of which holds an optical element;
a first driving unit configured to move the first holding portion with respect to the first component; and
a second driving unit configured to move the second holding portion with respect to the second component,
wherein the first component has a guide member configured to guide the first holding portion and the second holding portion in an optical axis direction, and
wherein the first driving unit is held by the first component, and the second driving unit is held by the second component.

2. The optical apparatus according to claim 1, wherein, when viewed from a radial direction, a part of each of the first holding portion and the second holding portion overlaps the first component or the second component.

3. The optical apparatus according to claim 1, wherein the guide member comprises a first guide portion configured to guide the first holding portion in the optical axis direction, a first restricting portion configured to restrict rotation of the first holding portion about the optical axis, a second guide portion configured to guide the second holding portion in the optical axis direction, and a second restricting portion configured to restrict rotation of the second holding portion about the optical axis.

4. The optical apparatus according to claim 3,
wherein the first driving unit is disposed, in a circumferential direction, closer to the first guide portion than to the first restricting portion, and
wherein the second driving unit is disposed, in the circumferential direction, closer to the second guide portion than to the second restricting portion.

5. The optical apparatus according to claim 1, wherein the guide member has a first guide portion that guides the first holding portion in the optical axis direction, a second guide portion configured to guide the second holding portion in the optical axis direction, and a common restricting portion configured to restrict rotation of the first holding portion and the second holding portion.

6. The optical apparatus according to claim 1, wherein, during zooming, a maximum value of a moving distance of the second holding portion is smaller than a maximum value of a moving distance of the second holding portion.

7. The optical apparatus according to claim 1, wherein, when zooming is performed at a constant speed, a maximum value of a moving speed of the second holding portion is smaller than a maximum value of a moving speed of the second holding portion.

8. The optical apparatus according to claim 1, further comprising a detection unit configured to detect a moving distance or a moving speed of the second holding portion with respect to the first component,
wherein the detection unit is held by the first component.

9. The optical apparatus according to claim 1, further comprising a second detection unit configured to detect a moving distance or a moving speed of the second holding portion with respect to the second component,
wherein the second detection unit is held by the second component.

10. The optical apparatus according to claim 1, wherein the first component and the second component hold optical elements different from the optical elements held by the first holding portion and the second holding portion.

11. The optical apparatus according to claim 1, wherein the first component and the second component move along an identical trajectory with each other during zooming.

12. The optical apparatus according to claim 1, wherein the first component and the second component move along different trajectories with each other during zooming.

13. The optical apparatus according to claim 1, wherein the first component and the second component move along different side surfaces of a common cam groove.

14. The optical apparatus according to claim 1, further comprising a flexible substrate for supplying power to the second driving unit,
wherein the flexible substrate is disposed so as to extend between the first component and the second component.

15. An imaging apparatus comprising:
the optical apparatus according to claim 1; and
an imaging element.

16. An imaging apparatus comprising:
an imaging element,
wherein the optical apparatus according to claim 1 is configured to be attachable and detachable.
